(19) United States
(12) Patent Application Publication
(10) Pub. No.: US 2008/0069079 A1
(43) Pub. Date: Mar. 20, 2008

(54) System and method for spectrum sharing

(75) Inventor: Michael W. Jacobs, State College, PA (US)

Correspondence Address: DUANE MORRIS LLP, Suite 700, 1667 K Street, Washington, DC, 20006, US

(73) Assignee: STAR-H Corporation

(21) Appl. No.: 11/522,924

(22) Filed: Sep. 19, 2006

(51) Int. Cl. H04B 7/212

(52) U.S. Cl. 370/348

(57) ABSTRACT

A system and method of predicting the availability of a communication channel in a frequency sharing spectrum based on the expected probability of near-term transmissions by other users, the priority of the communication, the type of waveform, channel noise sampling, and/or channel availability.

The U.S. Government has a paid-up license in this invention and the right in limited circumstances to require the patent owner to license others on reasonable terms as provided for by the terms of Contract No. DAAB07-03-C-J606 awarded by the U.S. Army CECOM.

This application is directed to a system and method for predicting the availability of a communication channel in a frequency spectrum sharing system.

There are a number of theoretical approaches toward the problem of predicting interference (collisions) among stations on a multi-user communications channel. The most well developed approaches come from communications theory but apply only to cases where the usage characteristics of all the stations on the channel are known in advance. Schemes such as ALOHA, which was developed for multi-access satellite uplink channels, presuppose a level of acceptable interference and allow for retransmission when a collision occurs. Most prior art systems concentrate on either methods of reducing collisions in systems where the behavior of all the units are under the designer's control, or on methods for correcting for lost data as the result of such a collision. None of the prior art systems are directed to predicting the specific future channel occupancy for non-cooperative multi-user systems.

Another prior art approach to address the problem has predicted channel blocking and interference probabilities using statistical techniques such as Markov chains. Such work has shown that with blocking probabilities of under 10% the gain in available spectrum can exceed 25%. However, such methods have only been useful when the usage characteristics of all the stations on the channel are known in advance.

The problems identified above directly limit the ability to analytically predict channel usage and collision frequency using any of the prior art systems. In the present disclosure, a system and method for predicting the availability of a communication channel in a frequency spectrum sharing system, where the usage characteristics of other stations are not known ahead of time, the number of stations on a channel are not known, and the duration of transmissions is not constant or predictable.

### BRIEF DESCRIPTION OF THE DRAWINGS

FIG. 1 is a simplified block diagram of the measurement portion of one embodiment of the present disclosure.

FIG. 2 is a simplified block diagram of the channel availability prediction portion of one embodiment of the present disclosure for use with the measurement portion of FIG. 1.

FIG. 3 is a simplified numerical example of the operation of one embodiment of the present disclosure.

### DETAILED DESCRIPTION OF THE DRAWINGS

Applicant has determined that while channel usage is random over large intervals, it can appear to be causal and predictable over short intervals. For example, applicant has determined that there is a larger correlation between the next minute's channel occupancy and the prior several minutes' occupancy than there is between the next minute's channel occupancy and that of an equal period several hours prior. Thus, in one aspect, applicant predicts the occupancy of a channel in the near term using the most recent past channel usage data for channels exhibiting random bursty transmission characteristics.

In another aspect of the present disclosure, the available channels are ranked by the expected probability of near-term transmissions by other users. Rapidly updated real-time data and the ability to process historical data over the recent past hour are used to implement the process is this aspect. In one aspect, the process assumes that the user of the spectrum sharing system has equal priority for the use of a channel with other potential users, known or unknown. In this case, once a channel is selected for utilization by one user, the spectrum sharing system will not allow another user to select the same channel while it is in use. In another aspect, the system assumes users of specific waveforms have higher priority and blocks the channels containing the waveforms from future access by the users of the spectrum sharing systems. In yet another aspect, the channel selection system may consider a user to have lower priority than other potential users. In this aspect, a channel noise sampling process is used periodically during the transmission of the lower priority user to determine the channel noise level. If another signal is present, the spectrum sharing system terminates transmissions on that channel by the low priority user and selects another channel available for use for the low priority user.

In order to assess the communication environment, all communication channels may be monitored at least once and preferable several times per second. Through repetitive monitoring of the communication spectrum, an accurate history of channel usage can be developed. Once an accurate usage history is established, predictive methods can be used to select a channel likely to be available. In one aspect of the present disclosure, the channel selection process is based on evaluation of available frequencies based on three criteria:

(1) The most recent spectrum activity scan—If a channel shows activity in the current scan, it is presumed to be busy for the next operational period and is excluded from selection for use.

(2) Database of excluded frequencies—If a channel falls within a range of excluded frequencies, it is excluded from selection for use.

(3) Availability prediction based on historic use—The channel prediction algorithm attempts to reduce the chances of interference by steering the channel selection to those frequencies which are least likely to show activity by other stations in the next operational period.

With respect to channel availability prediction, the channels are ranked as a function of their past activity levels. Whether a channel is available for the next operational period may vary as a function of the selected communication protocol. Operational period is the duration that the selected frequency will be used for transmission and thus the operational period may be a the duration of a single frequency hop, or the duration of a single push to talk transmission, or some other duration defined by the point where the operating channel is changed as updated spectrum measurement data requires.

The present disclosure is designed to accommodate spectrum over an entire communication spectrum. Five categories of expected signals over the spectrum of 30-450 MHz will be described for ease of illustration as this spectrum includes many types of commonly used communication signals, it being understood that the principles and methods described herein are equally applicable to other spectrums. The five categories are classified based on their temporal signatures:

(a) continuous signals which are associated with broadcasting, data services, and common carrier operations;

(b) regular periodic transmissions such as are found in radar and polling based data systems;

(c) bursty, long-duration (0.5 tens of seconds) traffic of a random nature, primarily even-driven system such as push-to-talk voice, to interrogative data communications services;

(d) rapid (less than 0.5 second) bursty data traffic from frequency hopping spread spectrum systems; and

(e) wideband low-energy signals from direct sequence spread spectrum and ultra-wideband (UWB) communication systems.

Signals in the first category are readily avoided by the basic channel selection algorithm of avoiding channels that are currently in use, since they will be present in each current spectrum scan, barring failures in the transmitting apparatus or occasional signal cancellation due to multipath effects at the receiver. Failure of a transmitter can present a window of opportunity to allow the short term reuse of the channel by the spectrum sharing system until the broadcast signal reappears. Loss of signal from a short term multipath cancellation effect would not present such an opportunity, and is effectively dealt with through the prediction algorithm presented here. In one aspect, the channel usage predictive algorithm will ensure that a long-term broadcast signal that weakens for a short period (several seconds) will still be ranked low based on the prior measured signals on that channel, and thus it will not be selected unless there are no other available channels with lower occupancy and less likelihood of interference. In addition to analog and digital broadcasting, continuous or nearly continuous operation is seen in digital paging systems, CDMA cellular communications systems, and as idle tones on older analog voice communications systems such as IMTS. High volume packet data systems may also exhibit these characteristics.

Regular periodic signals of the second category which are mostly from radar systems are best avoided to prevent interference to friendly radars which may see unexpected on-channel transmissions as an off-axis signal and produce a false return (or mask a real one), or whose powerful main beam may cause interference to other receivers. In the case of enemy radars, operation on their frequencies may interfere with signals intelligence gathering operations, or risk jamming if a friendly jammer is brought online (or worse if an anti-radar missile is fired at the radar). In one aspect of the present disclosure, a database may be maintained of these frequencies to exclude them from selection by the predictive algorithm.

In the 30-450 MHz band, the 400-450 MHz band is used for airborne search radars by aircraft such as the E-2C Hawkeye. Other radar systems operating from fixed sites include aerial and space surveillance and other applications are located in various portions of the VHF and UHF bands. In another aspect of the present disclosure, these signals will be automatically excluded by the predictive channel usage algorithm based on the strength of these signals over a wide area.

In one aspect of the present disclosure, waveform identification can be used by the predictive algorithm to assist in the identification of an available channel. For example, a list of waveforms that should be excluded could be maintained in a database and thus any channel utilizing an excluded waveform would not be selected by the algorithm.

The third category of bursty long-duration signals has historically represented the largest portion of spectrum usage in the bands optimal for mobile communications. However, this band is the most inefficient, and thus many prior art spectrum sharing systems have been directed to this category of signals in order to permit greater overall throughput of information. Because the bursts of transmissions tend to be triggered by external events (such as a police officer reporting a speeding vehicle or a combat unit reporting sighting an enemy column), the ability to predict specific activity on a particular channel has previously not been attempted in the prior art. The methodology being implemented here is based on the observation that such communications tend to occur in groups of transmissions, as users initiate and reply to communications. Once the exchange is complete, the channel falls dormant again. Transmissions on these types of channels tend to range from one second to a few tens of seconds in length and the exchange may last anywhere from under a minute to several tens of minutes. Thus, in one aspect of the present disclosure, channels are identified as having a higher probability of activity in the immediate future on the basis of the measured activity in the prior several minutes. Thus, the present prediction algorithm may be used to steer traffic to those channels without recent activity and without a history of high-volume or regular periodic transmissions.

The fourth type of signals are transmissions from frequency hopping systems, such as SINCGARS, that are ideally completely random in nature for communications security purposes. They are constructed so that it is intended to be impossible to predict where the system will hop next based solely on traffic analysis. If that was not the case, enemies would be able to develop effective jamming systems to impair the use of these systems. In areas where there are only a few operational SINCGARS networks, the short duration of each on-channel transmission and the large number of available channels will work to make on-channel interference sufficiently unlikely that the resulting collision rate will fall within the ability of the SINCGARS error correction coding scheme to fix the error. In areas where large numbers of SINCGARS systems are operational, the simplest solution is to program the assigned SINCGARS system hop sets into the channel selection system's frequency exclusion database, or to have the SINCGARS systems coordinate their frequency hops over the network order wire system being implemented for coordinating the operation of the spectrum sharing system.

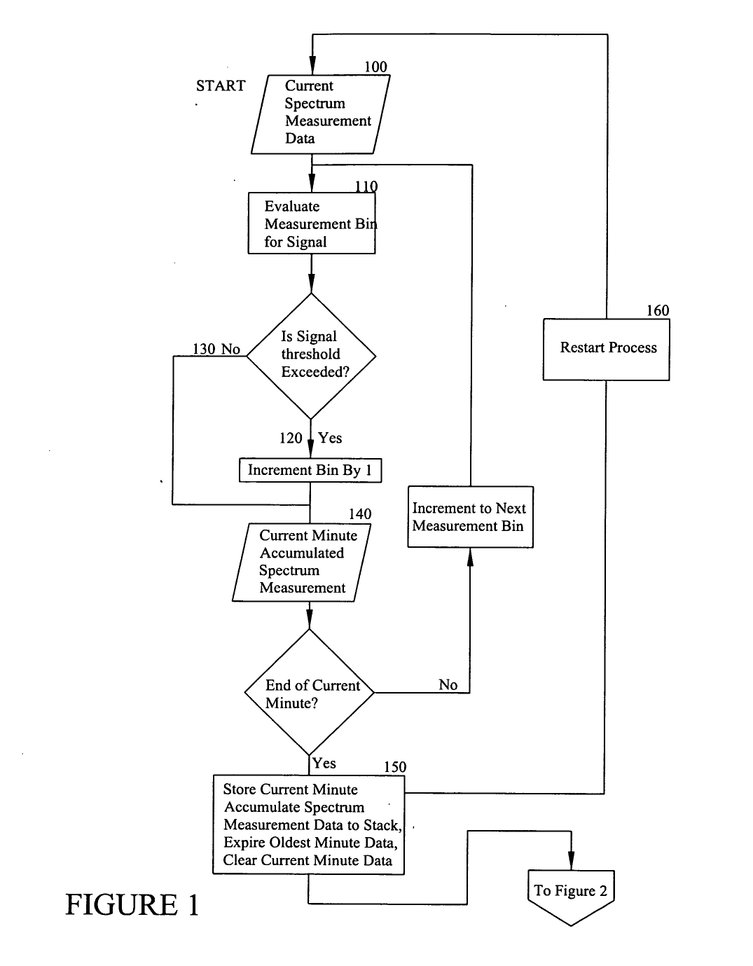

FIG. 1 is a simplified flow chart of one embodiment of the present disclosure. One feature is to assign a probability ranking to each measurement bin across the measurement range. The channel selection algorithm then uses these rankings, along with the most current real-time spectrum measurement, and its database of excluded frequencies to select a channel with a low likelihood of a collision. The algorithm presupposes that the communications system being assigned the channel will only be using the channel for a short bust transmission. The longer the transmission time, the greater the change that the probability prediction breaks down and a collision occur. For systems requiring a broadcast channel, the system database in the spectrum sharing system can modify the selection criteria to only select channels with low levels of activity over the entire historical measurement period. The present application is adaptable to simplex transmissions on the selected channel, or half and full duplex systems.

In operation, the communication spectrum is divided into a series of frequency bins and the activity for each bin is measured periodically for the entire spectrum. Ideally, the spectrum measurement would consist of a peak hold value for each measurement bin over the entire frequency range, with a scan rate of several complete measurements each second. However, a scan rate of approximately once per second is acceptable. The longer the scan time, the greater the chance that short duration transmissions will be missed. Scan time is determined by the hardware implementation for the receiver and is discussed further below.

With reference to the flow chart of FIG. 1, the most recent measurement data 100 being input from the receiver into the spectrum control processor, which is running routines for both the channel selection and for the channel prediction functions. The channel prediction function continually calculates a real-time data record for the entire measurement spectrum with a weighted value in each measurement bin corresponding to the calculated probability that a channel will be unoccupied for the next second. The current second's measurement data 100 consists of a peak power level measurement for each measurement bin across the entire measurement spectrum for the last measurement period (periods if we can scan faster than once per second). This data is then compared bin by bin 110 to a predetermined threshold level to indicate whether an external signal is breaking the noise floor of the receiver. Each bin with a signal breaking the noise floor threshold is assigned a numerical value 120. If the measurement bin does not exceed the threshold, the measurement bin is not incremented 130. (For ease of illustration the measurement bin will be incremented by 1 if it exceeds the threshold or 0 if it does not.) Every second, the numeral results are added bin by bin to the current minute's accumulated data record 140, such that a continuous broadcast signal would have a value of 60 for each bin it occupies, and a signal with only one 1-second transmission would have a value of 1 for each bin it occupies. Unoccupied bins would have values of 0 for that minute. At the end of every minute, the current one-minute accumulated record is stored 150 and a new current minute record is started 160.

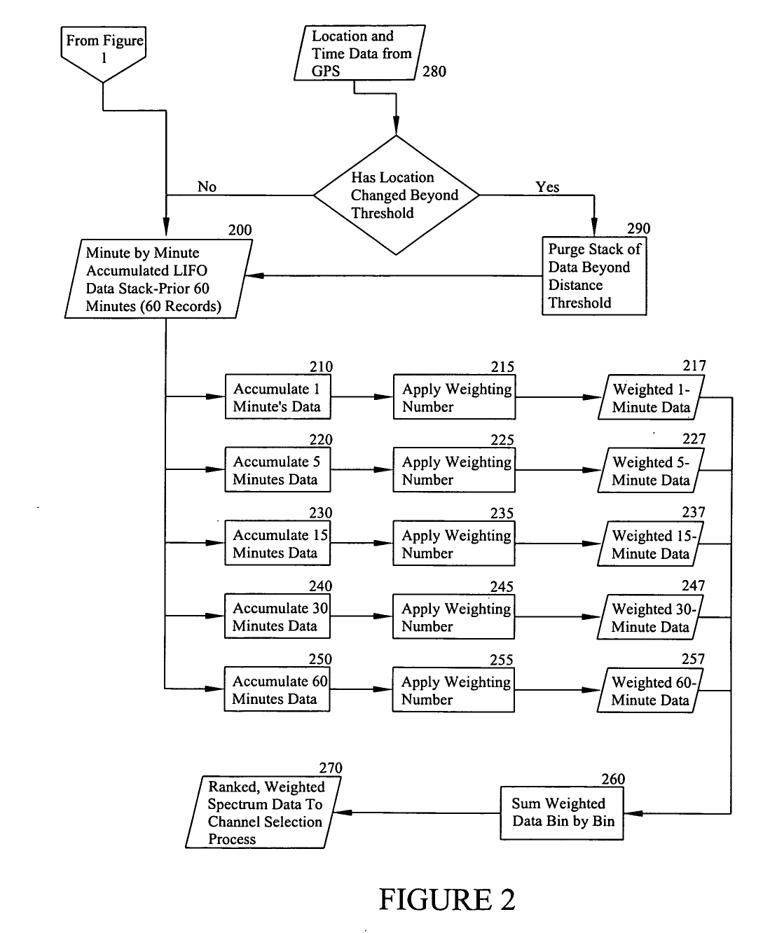

FIG. 2 illustrates the operation of the channel availability prediction process based on the measurements from FIG. 1. Sixty minutes worth of one-minute records are stored in a LIFO stack 200, such that every minute the new record is added to the top of the stack and the last record is discarded. The channel prediction algorithm calculates several totals of these records each second. Totals are calculated for the most recent five, fifteen, thirty and sixty minutes 220, 230, 240, 250. These totals along with the current minute total 210 (which is updated once each second) are then multiplied by a weighting constant chosen for each time period selection 215, 225, 235, 245, 255 to provided weighted data for each time period 217, 227, 237, 247 257. The weighting constants are chosen such that the most recent time periods are weighted higher than the older time periods. After the weightings are applied to each record they are summed together 260 to create an aggregate ranking record 270 for reach measurement bin. Bins with higher values represent frequencies that have a high probability of a collision. Bins with lower values are less occupied and are more likely to be interference free if chosen.

The values of the weighting constants and the cutoff threshold chosen for other acceptable aggregate ranking numbers will determine the ultimate number of collisions which result, and the overall error rate. In practice, the acceptable collision rate will depend on operational considerations including the relative importance of the operating communications networks. A high priority network may want to reduce its probability of being blocked by impressing a higher collision rate on the other users of the spectrum. A low priority network, or operation in an area where interference must be minimized will result in a higher chance of blocking. Thus the present disclosure allows of selectively choosing the weighting constants as a function of the communication environment.

Initially, it may seem that it would be best to only select those channels with the absolute lowest probability of interference. In practice, however, in situations where the spectrum occupancy reduces the number of ideal channels to select this could result in a security issue as the number of potential channels falls low enough that enemy traffic analysis could exploit this weakness and predict the operation of the system. Thus, there is a tradeoff between security and interference potential, and the weighting constants can be selected to influence the operation of the spectrum sharing system to take these factors into account.

In one embodiment of the present application, the spectrum monitoring system may be deployed on a mobile platform, such as a mobile phone or radio. In the event that the spectrum monitoring system is in motion, or is shut down and relocated, stale data from a location in excess of a predetermined threshold can be purged. During measurement, each data record is tagged with the time when the measurement was made and the location where the measurement was made 280. If the tagged location on a stored record exceeds a predetermined distance from the current location of the measurement system, the record is discarded 290 and not used in the channel availability prediction.

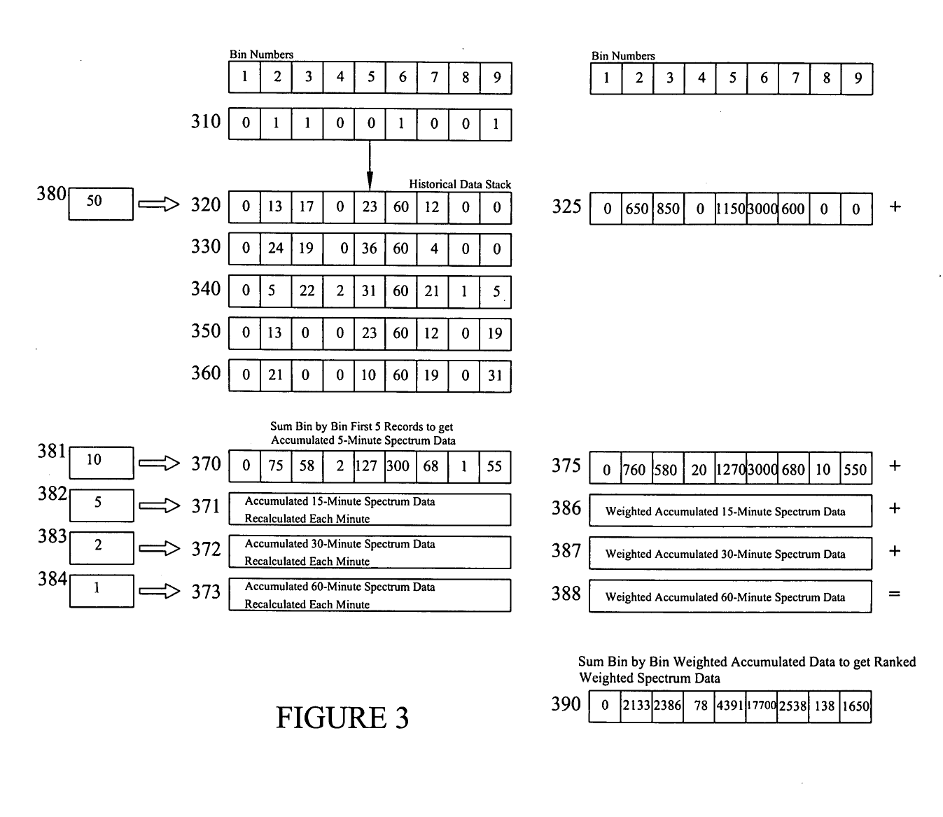

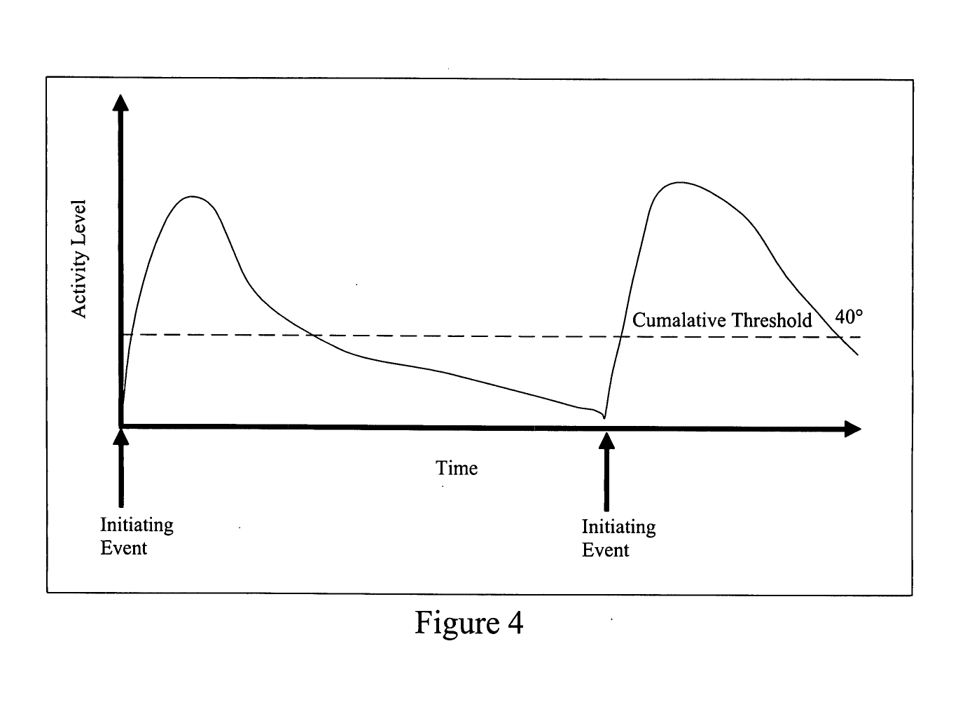

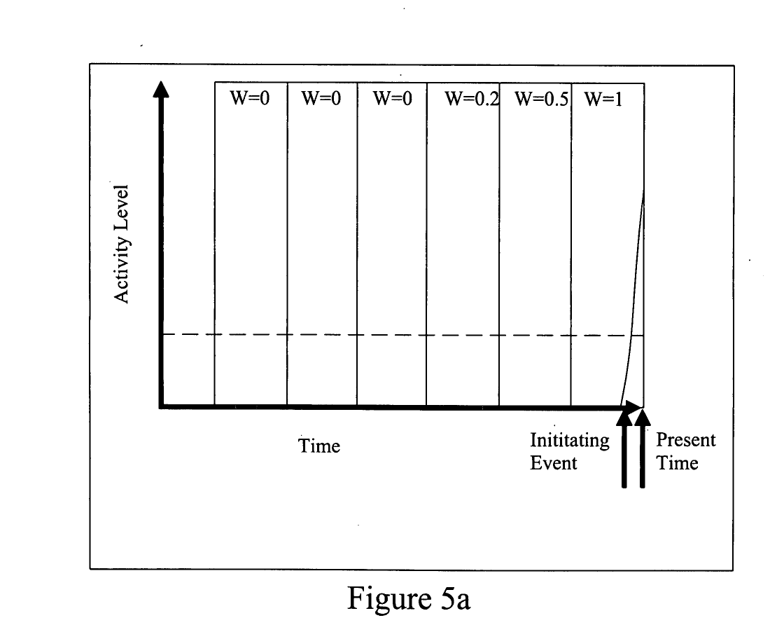

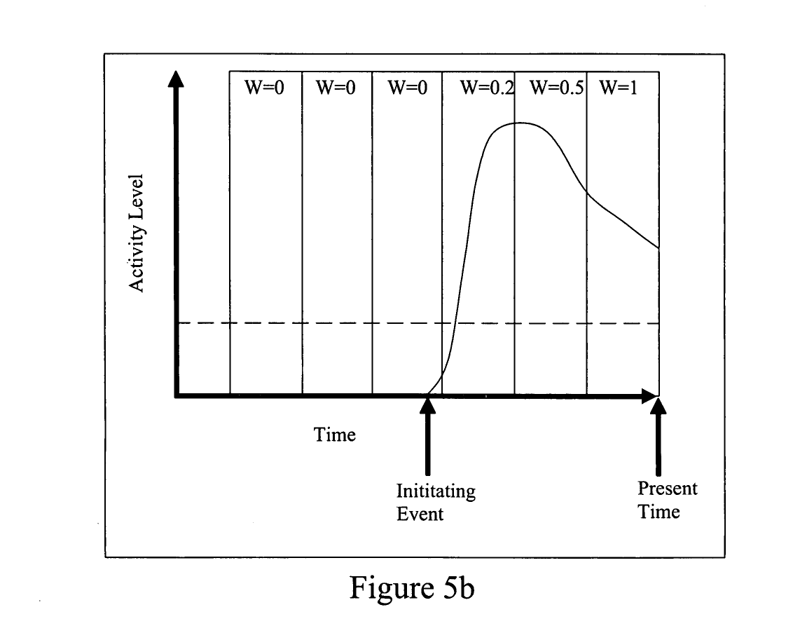

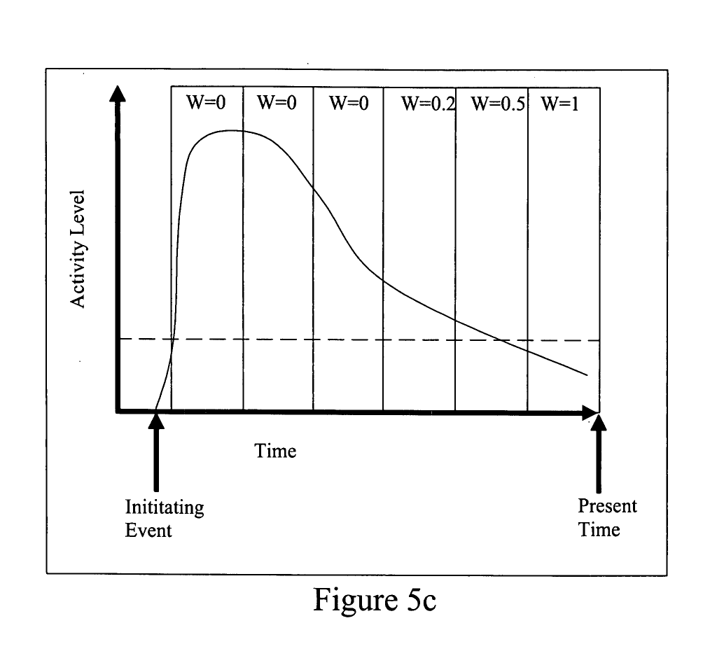

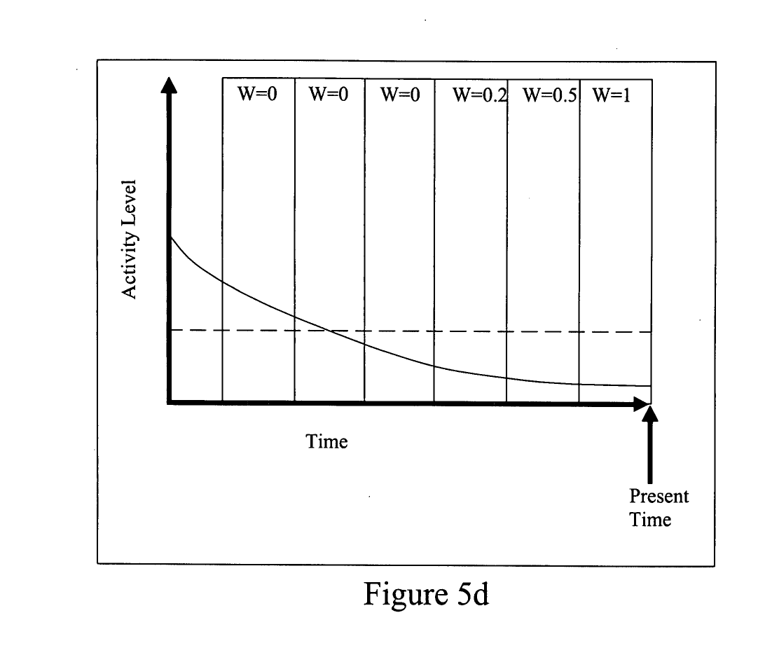

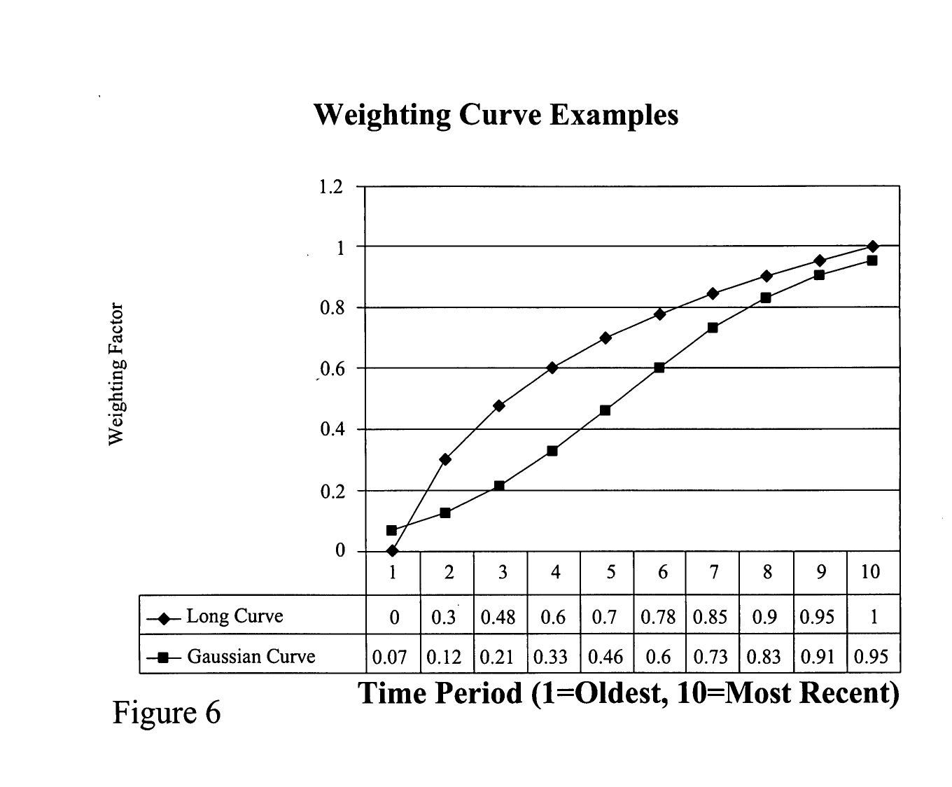

FIG. 3 represents a numerical example of one embodiment of the present disclosure. In this example, measurements of the entire spectrum are taken once every second. Bins 301-309 are shown with their measurement history over the previous 60 minutes. The current second's measurement enters the process 310 showing signals present on the second, third, sixth and ninth bins. The values for the current second's measurement 310 are added bin by bin into the current minute's accumulated data 320. This gives the number of seconds out of the current minute (or part of minute) in which a signal was detected in each bin.

Values for the previous four minutes are shown on a minute by minute basis 330, 340, 350, 360. The system store values for the previous five minutes 370, fifteen minutes 371, thirty minutes 372 and sixty minutes 373 which each bin being updated every second.

As shown in FIG. 3, bin number 1 remains unoccupied over the entire five minute period. Bin number 6 is continuously occupied by a broadcast signal. Bin number 9 has had recent activity, but it is currently unused.

Once each second, the current minute's data 320 is multiplied by the weighting function 380 to provide a weighted current minute data 325 for each of the bins. The current second is added to the accumulated five minute data 370 and weighted by a weighting function 381 to provide a weighted five minute data 375 for each bin. Likewise, weighting factors, 382, 383 and 384, are multiplied by the accumulated fifteen minute data 371, accumulated thirty minute 372 and accumulated sixty minute data 373, respectively, to provide weighted data for the accumulated fifteen minute period 386, accumulated thirty minute period 387 and accumulated sixty minute period 388, respectively. These values are then summed bin by bin to generate a weighted overall spectrum record 390. For example, bins 1, 4 and 8 show low usage weighted overall spectrum record 390 and would be selected first by the channel selection process unless they were otherwise excluded or active in the current second's measurement 310. The high value of bin 6 is indicative of a continuous broadcast signal making bin 6 unavailable for use. Once each second, the weighted current minute data 325 is updated. Once each minute, the weighted five minute data 375, fifteen minute data 386, thirty minute data 387, sixty minute data 388 and overall summary are updated.

FIG. 3 is only one example, it being understood by one of skill in the art that scan rates and update time periods may be altered and channel availability prediction my be based on a time period other than the overall summary 390. The time period for evaluation may be selected according to the typical duration of the activity required to resolve the event, and the typical duration of the unrelated communication to be inserted on the channel. For communications channels involving push-to-talk transmissions, e.g., voice communications for police, fire, EMS, taxicab dispatching, small combat unit operations, plant maintenance, etc., the time scales tend to be human-scale, involving the time it takes for a unit to be notified of a incident, transport itself to the location of the incident, make initial reports upon arrival, resolve the incident, and return itself to its base location. For the case where humans are operating the communications channel and handling the situation, the durations of each of these stages are typically measured in minutes, with the overall duration averaging on the order of one hour. For example, a fire is reported to the dispatch center. The dispatch center transmits a notification to the fire units to respond to the situation, this is the first observed communication on the channel following the initiation of the incident. Units respond to the dispatch, report their status via radio, and communicate updated information while enroute to the scene of the fire. In most areas, this takes place in a matter of a few minutes. Depending on the nature of the emergency, crews may be on the scene for a very short time (such as for a false alarm), or a longer time depending on how long it takes to resolve the situation. Minor situations requiring shorter resolution times far outnumber situations with longer resolution times (major fires in this example), so the greatest need to weigh channel activity is within a short period of time from the observation of a newly initiated communication. Because the prediction algorithm operates in a rolling fashion, longer duration situations will be accounted for because their channel usage will be recurring even as older activity drops off.

In one embodiment, the disclosed predication method may be used to make auto-mated channel assignments for non-cooperative sharing of communications channels. Using push-to-talk as an example, whose duration will be on the order of a few to several tens of seconds, the goal is to identify when the probability of a transmission on a channel is low over the next few to several tens of seconds so that this transmission may be inserted without negative effect. If there is a need to insert a 30 second transmission onto a shared communication channel without interference, then an important indicator of whether interference is likely is an evaluation of what activity has been occurring on the channel over the previous minutes, with the importance of past activity as a predictor of immediate future activity diminishing quickly over time. For example, data that is 30 minutes old is less valuable than data that is 2 minutes old.

The precise time period that is evaluated is not critical provided that it is large relative to the intended transmission duration. Processing efficiency, and data storage requirements, however, militate toward the use of the shortest possible time period to keep system processing costs low. For example, if the intention is to insert a rapid data transmission onto a non-cooperatively shared channel, then the time period to be monitored can be significantly reduced. A 100 millisecond Bluetooth data packet transmission may only require the prediction system to monitor a channel over the previous 10 or 15 seconds. For this system the initiating event may be a user mouse click or keypad activation. A typical computer user may go through periods of several minutes without any inputs, as when reading a document, or may be rapidly making inputs as when typing a document. In the former case, the prediction algorithm will score the channel as available, while in the latter the continuously logged activity will prompt the algorithm to score the channel as busy, even if the user momentarily rests from making an input, thus avoiding interference.

FIG. 4 is a simplified graph of channel activity versus time of an event-driven communications system. When the channel activity dips below the threshold 400, there is an opportunity to share the channel with an acceptable probability of causing or receiving interference. Busier channels with initiating events more closely spaced may never meet the qualifications for sharing. To keep the probability of interference low, the duration of the intended transmission should be much less than the duration during which the channel activity is below threshold. 400 This curve holds whether the duration is milliseconds or hours.

FIGS. 5(a)-(d) illustrates a time sequence showing how time-weighted channel score decreases as activity diminishes over time (activity curve shifts to left). For simplicity, only three weighting periods are shown, but as many as are necessary can be added. The time duration of the weighting periods need not be uniform, i.e., several periods could be given the same weighting factor, W. In general, the weighting factors will be highest for the immediate weighting period.

In FIG. 5(a) the present time activity level for a channel is higher than the cumulative threshold 500 but the initiating event is recent resulting in a cumulative weight of approximately 1 representing a high probability of interference. In FIG. 5(b), the activity level at the present time is higher than the cumulative threshold and the cumulative weighting would be about 1.7 indicating a high probability of interference. In FIG. 5(c), the activity level at the present time has dropped off below the cumulative threshold 500 with the cumulative weight of approximately 0.7 indicating a moderate probability of interference. In FIG. 5(d), the present activity has remained below the cumulative threshold for some time resulting in a cumulative weight of 0 representing a low probability of interference. Depending on the urgency of the intended communication, the tolerable level of interference, and the availability of alternative channels, either the low or moderate scored cases could be used for shared communications.

The values of the optimal weighting factors to be used may vary depending on the channel activity and characteristics. In practice, the greatest weight will be given to the immediate measure time period. The weights will reduce as older data is considered, going to zero at the point where the channel activity is judged to be no longer relevant to making a prediction. In one embodiment, the weighting factors may be based on various exponential and logarithmic curves. The curve is fitted to the time period of interest and weighting factors assigned ranging from 1 to 0. FIG. 6 illustrates two examples of weighting curves which may be used. The Gaussian (Normal) curve weights more recent activity higher than older activity compared with the exponential curve. The specific weighting factors which give the best prediction will vary depending on the nature of the communications activity on a given channel. For example the Gaussian curve may be used with push-to-talk communications. In another embodiment, the weighting function values are determined on a continual basis by comparing predicted occupancy patterns with actual measured occupancy, then applying an optimization algorithm to the historical data set to minimize the error function.

While preferred embodiments of the present invention have been described, it is to be understood that the embodiments described are illustrative only and the scope of the invention is to be defined solely by the appended claims when afforded a full range of equivalents, many variations and modifications naturally occurring to those of skill in the art form a perusal hereof.

What is claimed:

1. A method of predicting the availability of a communication channel from a plurality of communication channels in disparate communication systems comprising the steps of:
(a) assigning a measurement bin for each communication channel;
(b) periodically monitoring the signals levels for each communication channel;
(b) evaluating the signal level for each communication channel against a predetermined threshold level;
(d) incrementing a numerical value of the measurement bin associated with each communication channel that exceeds a predetermined threshold;
(e) selecting a communication channel for transmission as a function of the numerical value of the measurement bins.

2. The method of claim 1 wherein the plurality of communication channels are monitored at least once each second.

3. The method of claim 1 wherein the availability of the communication channels are ranked as a function of the numeral values of their associated bins

4. The method of claim 1 wherein the step of selecting further comprises:
(i) maintaining a plurality of records for each of the bins, each record having a time interval;
(ii) weighting the records as a function of the time interval;
(iii) determining a numerical value of each bin as a function of its associated record;

5. The method of claim 4, wherein the step of determining comprises adding the weighted values of the records for each bin.

6. The method of claim 1 wherein the step of selecting includes selecting the communication channel having the bin with the lowest numerical value.

7. The method of claim 4 wherein each bin has a first record of a one second time interval representing a measurement value of the current second, second through sixth records of one minutes interval corresponding to the measurement values for the previous five minutes, respectively, a seventh record having a five minute interval corresponding to the accumulated value of the second through sixth records, an eighth record having a fifteen minute interval, a ninth record having a thirty minute interval and tenth record having a sixty minute interval.

8. The method of claim 7 wherein records of longer time intervals are weighted less than records of shorter time intervals.

9. The method of claim 6 further comprising maintaining a database of excluded frequencies and preventing the selection of a communication channel associated with the excluded frequencies.

10. The method of claim 1 wherein the communication channels are used by communication systems having non-compatible communications protocols.

11. The method of claim 6 wherein the selecting excludes communications channels having s signal above the predetermined threshold for the current measurement.

12. The method of claim 1 wherein the step of monitoring includes measuring a signal characteristic, time stamping the measurement and noting the location of the measurement.

13. The method of claim 12 wherein the measurements are maintained in a database.

14. The method of claim 6 further comprising classifying the measured signals as a function of waveform and excluding a channel form selection for transmission as a function of the classification of the measured signal.

15. A method of predicting the availability of a communication channel for use in a communication system having plural communication channels, comprising:
(a) evaluating the current use of a communication channel;
(b) evaluating if the communication channel is excluded from selection
(c) predicting the expected use of the communication channel;
(d) selecting a communication channel for use as a function of steps (a), (b) and (c).

16. The method of step 15 wherein the step of evaluating the current use includes measuring at least one characteristic of a measurement channel and comparing the measurement to a predetermined threshold.

17. The method of claim 16 wherein the step of evaluating if a communication channel is excluding from selection includes maintaining a database of excluded frequencies and identifying communication channels associated with the excluded frequencies.

18. The method of claim 15 wherein the step of predicting the expected use includes maintaining a moving weighted average of the past use of the communication channel.
